(19) United States
(12) Patent Application Publication
(10) Pub. No.: US 2022/0154489 A1
(43) Pub. Date: May 19, 2022

(54) DOOR PULL

(71) Applicant: ASSA ABLOY Accessories and Door Controls Group, Inc., New Haven, CT (US)

(72) Inventors: Michael Connell, Connellsville, PA (US); Catelyn Herman, Berlin, PA (US)

(21) Appl. No.: 17/528,508

(22) Filed: Nov. 17, 2021

Related U.S. Application Data
(60) Provisional application No. 63/115,207, filed on Nov. 18, 2020.

(51) Int. Cl. E05B 1/00; E05B 53/00

(52) U.S. Cl. CPC E05B 1/0015; E05B 53/001

(57) ABSTRACT

A door pull may be arranged to be operated with a foot or a tool close to the floor. The door pull may include a central portion allowing a user to actuate a door by bringing the foot or the tool in contact with the door pull. The door pull may further include a central portion which includes a serrated top edge, configured to make ergonomic and comfortable contact with a sole of a shoe, and a smooth lower edge, configured to make ergonomic and comfortable contact with a toe box of a shoe.

### RELATED APPLICATIONS

This application claims the benefit under 35 U.S.C. § 119(e) to U.S. Provisional Application Ser. No. 63/115,207, filed Nov. 18, 2020, entitled “DOOR PULL”, which is herein incorporated by reference in its entirety.

### FIELD

Disclosed embodiments are related to a door pull, and more particularly to a door pull suitable for actuation by a user's foot.

### BACKGROUND

A door is commonly provided with a door handle that allows a user to actuate the door. The handle is typically spaced distally from the axis around which the door rotates to allow the user to actuate the door with minimal force due to the long moment arm between the handle and the axis.

### SUMMARY

In some embodiments, a door pull operatively couplable to a door comprises a central portion offset from the door by a clearance distance and a plurality of side portions arranged to connect the central portion to the door. The central portion may further comprise an upper edge and a lower edge, wherein the upper edge comprises an upper topography and the lower edge comprises a lower topography that is different from the upper topography.

In some embodiments, a door pull operatively couplable to a door comprises a central portion offset from the door by a clearance distance and a plurality of side portions arranged to connect the central portion to the door. The central portion may further comprise an upper edge and a lower edge, wherein the upper edge comprises a plurality of teeth and the lower edge is relatively smooth.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective top view of one embodiment of a door pull;

FIG. 2 is a top view of the door pull;

FIG. 3 is a bottom view of the door pull;

FIG. 4 is a front view of the door pull;

FIG. 5 is a side view of the door pull

FIG. 6 is a front view of the door pull installed on a door; and

FIGS. 7A and 7B are perspective top views of the door pull installed on a door and as actuated by a user's foot.

### DETAILED DESCRIPTION

It should be understood that aspects are described herein with reference to certain illustrative embodiments and the figures. The illustrative embodiments described herein are not necessarily intended to show all aspects, but rather are used to describe a few illustrative embodiments. Thus, aspects are not intended to be construed narrowly in view of the illustrative embodiments. In addition, it should be understood that certain features disclosed herein might be used alone or in any suitable combination with other features.

A door may typically include a door handle to allow a user to open and close the door by grasping and exerting a force on the door handle. The door handle is commonly placed distal from the axis around which the door rotates to maximize the moment arm and allow the user to open the door with minimal force. The door handle is also typically spaced at an intermediate position between the top of the door and the floor. This spacing allows a user to grasp the handle using their hand or a portion of their arm.

Additionally, the door handle is frequently grasped by many different people during a given period of time. However, as multiple individuals touch the door handle, those individuals may transfer microorganisms onto the door handle and/or come into contact with microorganisms already retained on the door handle. Some microorganisms may serve to cause diseases, such as COVID-19, the flu, or other illnesses. Thus, as a given door handle is used by multiple individuals, the risk of a subsequent individual contracting a disease from the door handle increases. The inventors have appreciated that a shoe or a foot may be less likely to transmit contaminants and pathogens such as microorganisms as they are less likely to be in contact with vulnerable body parts, such as the face or hands.

The inventors have also appreciated that a user may not have access to typical door handles. This may be because the user is holding an object or a child with their hands and is not able to release their hold to grasp the door handle. Alternatively, the user may not have functionality of their arms or upper appendages, or may be situated lower than the intermediate position of the door handle (for example, if the user is sitting in a wheelchair). Therefore, the position of the door handle may limit the accessibility of the door.

In view of the above, the inventors have recognized the benefits of a door pull configured to be actuated by a users' foot. The door pull is located low to the floor to allow a user to open a door using a foot, a prosthetic, or a tool close to the floor. In some embodiments of the present disclosure, the door pull may include a surface (such as a serrated surface) to improve the grip between the door pull and the user's foot or tool, and more effectively transfer the pulling force from the user to the door to actuate the door. According to some embodiments of the present disclosure, the door pull includes a clearance distance between the actuation portion and its mounting region to allow a user to place a portion of their foot or tool within the door pull and thereby actuate the door.

In some embodiments, the door pull may include an octagonal “U” shaped body with a central portion, side portions, and flanges. The flanges may be planar bodies orientated parallel to the door, with through holes used to secure the door pull to the door using fasteners. The flanges may be a pair located at opposite ends of the door pull, each flange situated near a side portion. The side portions may first extend normal to the plane of the door and then extend at an incline angle, meeting at a central portion of the door pull. The central portion may be a planar body offset from the plane of the door by a clearance distance. In other embodiments, the door pull may include a smooth “U” shaped body, wherein the central portion and the side portions create a semi-circle between the flanges. In other embodiments, the outer surface of the door pull may have any suitable convex shape relative to the door, including, but not limited to, an arch, a semi-hexagonal, or semi-elliptical shape as the present disclosure is not so limited.

In some embodiments, the door pull may be symmetric around an axis extending normal to the plane of the door and central to the door pull. The side portions may be similar on either side of the axis and may transition into the central portion with the same geometry on either side of the axis. In embodiments where the door pull is substantially polygonal or angular, the transition between neighboring portions (for example, the region between a flange and a side portion, or the region between a side portion and the central portion) may be chamfered, smooth, radiused or sharp as the present disclosure is not so limited. In some embodiments, the upper and lower edge of any of the portions of the door pull may be chamfered, smooth, radiused as the present disclosure is not so limited.

In other embodiments, the door pull may be asymmetric around an axis extending normal to the plane of the door and central to the door pull. The side portions may differ in shape or size based upon their proximity to the door frame. An asymmetric door pull may allow a more ergonomic door opening experience for users with asymmetric shoes or tools. By conforming more closely to the shape of the shoes or tools used to actuate the door, the force applied by the user can more effectively be transferred to the door.

The flanges may include through holes to enable fastening of the door pull to the door. The door pull may be fastened to a portion of the door which may include a drillable material. In some embodiments, the door pull may be affixed to the door using attachment arrangement such as screws, bolts, hinges, adhesives, joints, and/or rivets. In other embodiments, the door pull may not include a through hole in the flanges and may be fastened to the door using magnets. In other embodiments, the door pull may be directly fastened to a secondary door pull on the opposing surface of the door by any of the attachment mechanisms described previously. In other embodiments, the door pull may be directly connected to a secondary door pull on the opposing surface of the door by a connection under the door, with the door pull being press fir to the door. This embodiment may be preferable when the door cannot be easily machined to accommodate the door pull, for example when the door is composed of glass.

In some embodiments, the door pull is installed on a portion of the door close to the frame of the door, away from the central axis around which the door rotates to maximize the moment arm and allow the user to open the door with minimal force. In some embodiments, the door pull may be installed on sliding doors such as a drawer. In these embodiments, it may be preferable to install the door pull central to the front face of the drawer to more effectively actuate the drawer.

In all embodiments, a clearance distance is measured from the plane of the door to the inner surface of the distal most point of the central portion away from the plane of the door. The clearance distance may be large enough to enable functionality for a large adult foot, but small enough to remain unobtrusive.

In all embodiments, a projection distance is measured from the plane of the door to the outer surface of the distal most point of the central portion away from the plane of the door. The projection distance may be large enough to enable functionality for a large adult foot, but small enough to comply with industry standards for door pulls. The projection distance may be the clearance distance in addition to the thickness of the central portion.

In all embodiments, an elevation distance is measured between the floor and the portion of the door pull closest to the floor. The elevation distance may be large enough to accommodate a large adult foot from the bottom of the door pull, but small enough to allow for comfortable use of the door pull. For example, if the elevation distance is too high, the user may be required to bend a knee or further contort a leg to pull on the door. This contortion may be uncomfortable and/or unstable for the user, may prevent access to users with limited leg mobility, and/or may collide with the shin or other portions of the user's leg.

In all embodiments, a center-to-center distance is measured between the central axis of the through holes on the opposing sides of the door pull. In some embodiments, the central axis of the through holes may be the center portion of the flanges, therefore, in some embodiments, the center-to-center distance may be measured as the distance between the center portion of the flanges on opposing sides of the door pull. The center-to-center distance may be large enough to enable functionality for a large prosthetic or a tool.

In some embodiments the door pull may be fabricated from a single planar rectangular piece of material and bent into shape for ease of manufacturing. In other embodiments, the door pull may be fabricated from a single planar non-rectangular piece of material and bent into shape for ease of manufacturing. It may be suitable for the door pull to have a non-uniform width profile or an angled width profile for more ergonomic functionality. For example, in some embodiments, it may be suitable for the central portion to have a curved bottom edge where the door pull may conform more accurately accommodate a user's shoes.

In other embodiments, the door pull may be fabricated from a single non-planar piece of material and bent into shape for ease of manufacturing. It may be suitable for the door pull to have a non-uniform thickness profile or an angled thickness profile for more ergonomic functionality. For example, in some embodiments, it may be suitable for the central portion to be thinner than the side portions for more structural rigidity.

In some embodiments, the door pull may be fabricated from a series of planar or non-planar components and joined together (for example by welding) to create an appropriate convex shape to accommodate the user's foot. Of course, the door pull may be fabricated with any suitable method, including, but not limited to, casting, molding or 3D printing, as the present disclosure is not so limited.

In some embodiments, the central portion may include topography on the upper edge and a smooth lower edge. In this embodiment, the topographical upper edge includes trapezoidal teeth to enable good contact between a user's shoe and the door pull without any permanent or adverse effects on the user's shoe. In other embodiments, the lower edge may include trapezoidal teeth to enable good contact between a user's shoe and the door pull without any permanent or adverse effects on the user's shoe. Of course, any edge of the door pull may be include any suitable two-dimensional or three-dimensional topography, including, but not limited to, sinusoidal waves, rectangular teeth, or frustrated cones, as the present disclosure is not so limited. In any embodiments where any edge of the door pull includes topography, the topography may serve to increase the friction between the door pull and the user's shoe or tool.

In some uses, the user may choose to place the sole of a shoe on the upper edge of the door pull to actuate the door. The user may press down with their shoe to ensure good contact between the shoe and the door pull, and then actuate the door. In some embodiments, the topographical upper edge of the central portion may improve the contact between the door pull and the sole of the shoe.

The user may choose to place the toe box of a shoe on the lower edge of the door pull to actuate the door. The user may raise the shoe into the door pull to ensure good contact between the shoe and the door pull, and then actuate the door. In some embodiments, the smooth lower edge of the central portion may improve the contact between the door pull and the toe box of the shoe, which may also be smooth.

In some embodiments, when the user's shoe or tool makes good contact with any edge or portion of the door pull, the user may then proceed to actuate the door in any desired direction. The side portions of the door pull may be substantially stiff to enable a user to push on the central portion of the door pull in a direction normal to the door to open the door without deforming the door pull.

The door pull may be composed of a material to minimize long-term wear on the door pull. For some applications, it may be desirable to coat the door pull with a material for various reasons. For example, and without limitations, the coating may produce a desired finish, protect the finish of the door handle, enhance friction, and/or provide an anti-microbial layer. In all embodiments, the upper and lower edges of the entire door pull may be finished in a manner to prevent any permanent or adverse markings, damage, or any other effects on the user's shoe.

Turning to the figures, specific non-limiting embodiments are described in further detail. It should be understood that the various systems, components, features, and methods described relative to these embodiments may be used either individually and/or in any desired combination as the present disclosure is not limited to only the specific embodiments described herein. For example, while the embodiments described herein refer to a door, the door pull may be attached to a cabinet, a drawer, an appliance door, etc. as the present disclosure is not so limited.

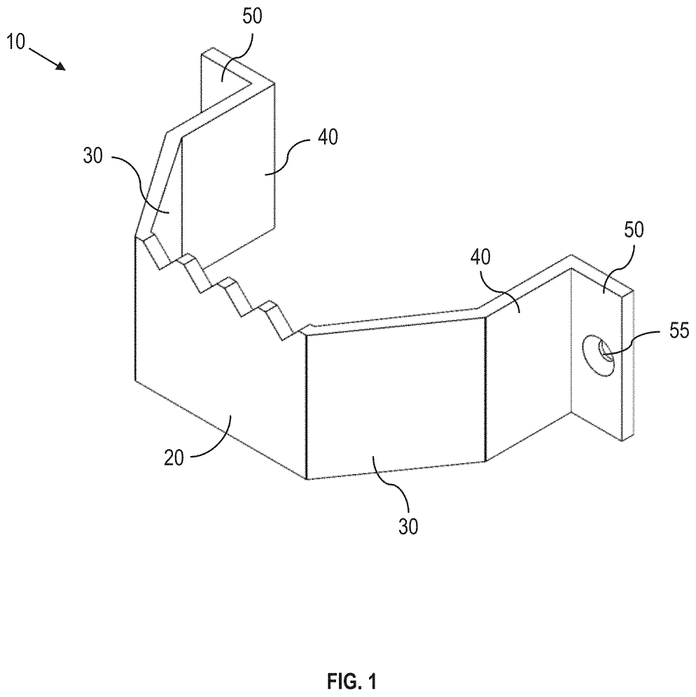

FIG. 1 is a perspective top view of the door pull 10, including a central portion 20, flanges 50, and side portions. As depicted in FIG. 1, the side portions may be a pair of first side portions 30 and a pair of second side portions 40. In some embodiments, the door pull 10 may include a single pair of first side portions 30 connecting the flanges 50 to the central portion 20. The flanges may further include a pair of through holes 55. In some embodiments, the through holes 55 may be threaded to allow a fastener such as a screw or a bolt pass through the flanges 50 in order to affix the door pull 10 to a door. In other embodiments, the through holes 55 may include a countersunk hole to hide the head of the fastener for aesthetic purposes. In other embodiments door pull 10 may be affixed to the door using alternative attachment mechanisms, such as an adhesive or magnets. In these embodiments, the flanges 50 may not include the through holes 55. In some embodiments, the flanges 50 may include multiple pairs of through holes 55.

The pair of second side portions 40 may extend normal to the flanges 50, and connect to the pair of first side portions 30, which may be inclined with respect to the flanges 50 and the pair of second side portions 40. The central portion 20 may be parallel to the plane of the door and the flanges 50. While the embodiment shown in FIG. 1 shows a door pull 10 with a semi-octagonal shaped body, the outer surface of the door pull 10 may have any suitable convex shape relative to the door, including, but not limited to, a substantially curved and/or smooth semi-circle, an arch, a semi-hexagonal, or semi-elliptical shape as the present disclosure is not so limited. In some embodiments, it may be suitable to combine the convex shapes listed above, as the present disclosure is not so limited. For example, in one embodiment, the central portion 20 is curved to provide a more ergonomic experience for the user, but the first side portions 30 may be planar for structural rigidity. In another example, the central portion 20 is planar for structural rigidity while the first side portions 30 are curved for aesthetic purposed.

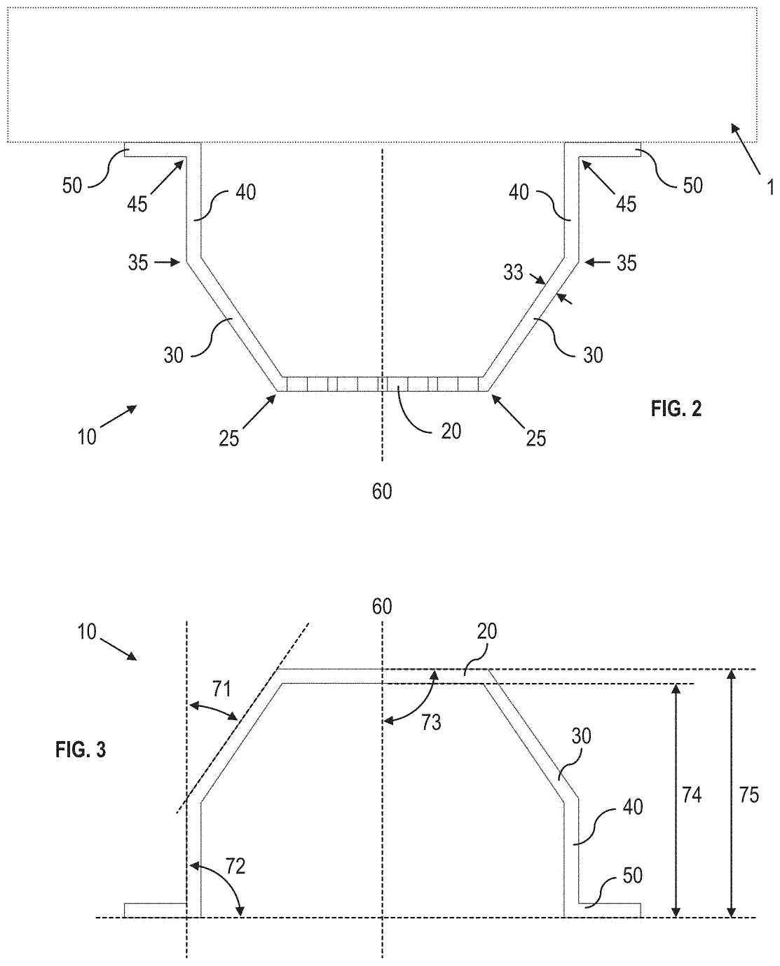

FIG. 2 is a top view of the door pull 10. In some embodiments, the door pull 10 may be symmetric about an axis 60 extending normal to the door 1 and central to the door pull 10. In these embodiments, each of the pair of first side portions are mirrored across the axis 60, and each of the pair of second side portions are mirrored across the axis 60. In other embodiments, the door pull 10 may be asymmetric around axis 60. In these embodiments, each of the pair of first side portions 30 may be different in shape or size across the axis 60, and each of the pair of second side portions 40 may be different in shape or size across the axis 60.

In some embodiments, the flanges 50 may be substantially planar for unobtrusive and aesthetic attachment to the door 1. The door pull 10 may have a uniform thickness 33 across the flanges 50, the second side portions 40, the first side portions 30, and the central portion 20, as depicted in FIG. 2. In some embodiments, the thickness may be between 1/16 inch to 3/16 inch, including 1/16, ⅛ and 3/16, though other suitable thicknesses may be employed as the present disclosure is not limited in this regard. In other embodiments, the door pull 10 may have a variable thickness across the flanges 50, the second side portions 40, the first side portions 30, and the central portion 20.

Door pull 10 may further include edges 45 between the flanges 50 and the second side portions 40, edges 35 between the second side portions 40 and the first side portions 30, and edges 25 between the first side portions 30 and the central portion 20. In some embodiments, edges 45, 35, and 25 may be chamfered, smooth, or sharp as the present disclosure is not so limited.

FIG. 3 is a bottom view of a door pull 10 symmetric about an axis 60, depicting a first angle 71 between the first side portions 30 and the second side portions 40, a second angle 72 between the second side portions 40 and the flanges 50, a third angle 73 between the axis 60 and the central portion 20, a clearance distance 74, and the projection distance 75. In some embodiments, the first angle 71 may be between 0° and 90°, including 25°, 35°, 45°, 55°, 65° and 75°.

In some embodiments, as depicted in FIG. 3, the second side portions 40 may be angled relative to the flanges 50 and the second angle 72 may be 90°. In other embodiments, the second angle 72 may be between 0° and 90°, including 0°, 20°, 40°, 60°, 80°, and 90°. As depicted in FIG. 3, the central portion 20 may be parallel to the plane of the door 1 and to the flanges 50. In this embodiment, the third angle 73 between the axis 60 and the central portion 20 is 90°.

In all embodiments, the clearance distance 74 is measured as the distance from the plane of the door to the inner surface of the central portion 20. In embodiments where the door pull 10 is substantially curved, the clearance distance 74 is measured as the distance from the plane of the door to the inner surface of the distal most portion of the door pull 10. In some embodiments, the clearance distance may be between 2 and 4 inches, including 2, 2.25, 2.5, 2.75, 3, 3.25, 3.5, 3.75, and 4 inches.

In all embodiments, the projection distance 75 is measured as the distance from the plane of the door when the door pull is installed on the door (which is also the plane of the mounting surface of the flange) to the outer surface of the central portion 20. In embodiments where the door pull 10 is substantially curved, the projection distance 75 is measured as the distance from the plane of the door to the outer surface of the distal most portion of the door pull 10. In some embodiments, the projection distance may be 3.0625 inches.

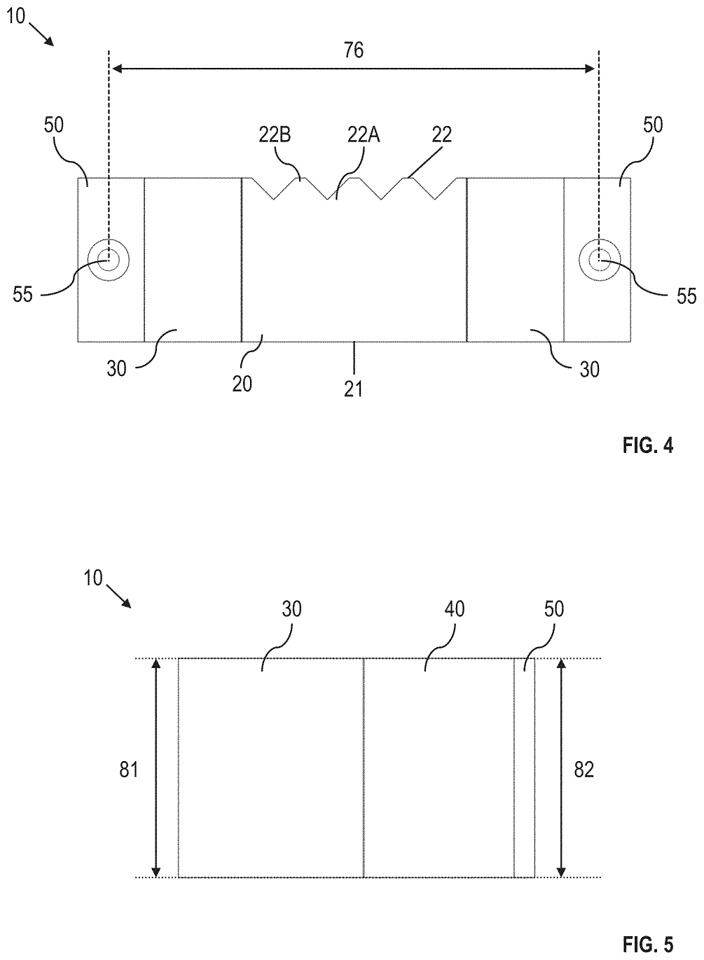

FIG. 4 is a front view of the door pull 10 depicting the upper edge 22 of the central portion 20, the lower edge 21 of the central portion 20, the through holes 55, and the center-to-center distance 76. The user may choose to actuate the door by pressing down on the upper edge 22 of the central portion 20 of the door pull 10 with the sole of their shoe.

In some embodiments, the door pull 10 may include trapezoidal teeth 22A on the upper edge 22 as depicted in FIG. 4. In these embodiments, the trapezoidal teeth 22A may include caps 22B to enable good contact between a user's shoe and the door pull without any permanent or adverse effects on the user's shoe. In other embodiments, the teeth may be sinusoidal or curved in nature, as the present disclosure is not so limited. In some embodiments, as shown in FIG. 4, the teeth may be equivalent in height and spacing. In other embodiments, it may be preferable to include a nonuniform pattern of teeth for improved contact between a shoe sole and the door pull 10. Although trapezoidal teeth 22A are shown on the upper edge 22 of the central portion 20 in FIG. 4, any edge of the door pull may be decorated with any suitable two-dimensional or three-dimensional topography, including, but not limited to, sinusoidal waves, rectangular teeth, or frustrated cones, as the present disclosure is not so limited.

Alternatively, the user may choose to actuate the door by pulling up on the lower edge 21 of the central portion 20 of the door pull 10 with the toe box of their shoe. In some embodiments, the door pull 10 may have a smooth lower edge 21 as depicted in FIG. 4, which may improve the contact between the door pull and the toe box of the shoe without damaging the top of the shoe. In some embodiments, both the upper edge 22 and the lower edge 21 of the central portion 20 may be smooth. In some embodiments, the upper and lower edge of the flanges 50, the second side portions 40, the first side portions 30, and/or the central portion 20 may be chamfered, radiused, smooth, as the present disclosure is not so limited.

In all embodiments, the center-to-center distance 76 is measured between the central axis of the through holes 55. In some embodiments, the central axis of the through holes 55 may be the center portion of the flanges 50, as shown in FIG. 4, therefore, in these embodiments, the center-to-center distance 76 may be measured as the distance between the center portion of the flanges 50 on opposing sides of the door pull. In some embodiments, the center-to-center distance may be between 2 and 8 inches, including 2, 2.5, 3, 3.5, 4, 4.5, 5, 5.5, 6, 6.5, 7, 7.5, and 8 inches.

In some embodiments, as depicted in FIG. 5, the first side portions 30 may have a width 81 that is equal to a width 82 measured for the second side portions 40 or the flanges 50. In some embodiments, the widths 81 and 82 may be between 1 and 4 inches, including 1, 1.5, 2, 2.5, 3, 3.5, and 4 inches. In other embodiments, it may be more ergonomic for the door pull 10 to have a non-uniform width across the central portion 20, the first side portions 30, and the second side portions 40. In these embodiments, the width 81 of the first side portions 30 may not be equal to the width 82 of the second side portions 40. Of course, the width across the central portion 20, the first side portions 30, and the second side portions 40 may be any suitable profile, including, but not limited to, linear or parabolic, as the present disclosure is not so limited.

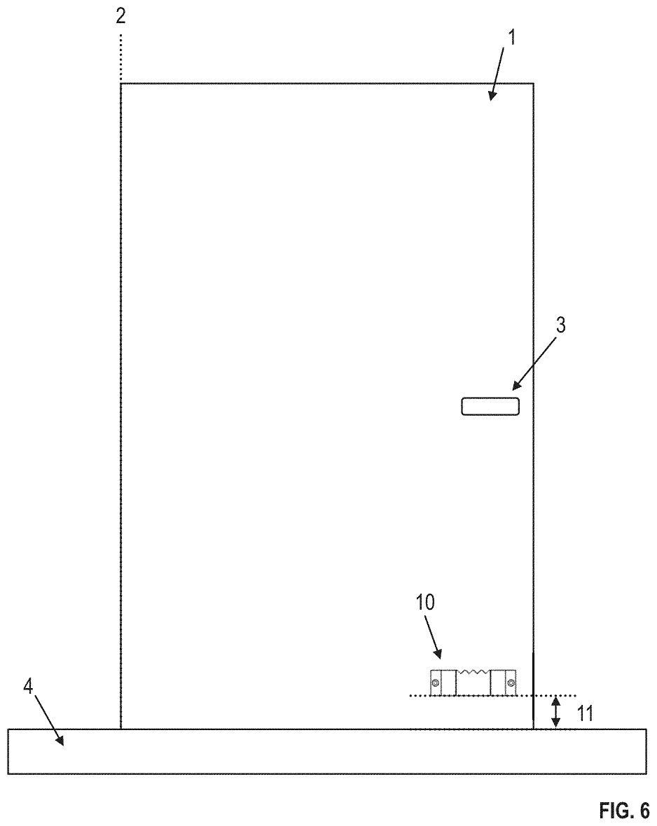

FIG. 6 is a front view of a door pull 10 installed on a door 1. In this embodiment, the door pull 10 is installed on a portion of the door 1 furthest away from the rotational axis 2 of the door 1. In this way, the user may benefit from a large moment arm and comfortably actuate the door 1 using the door pull 10. In some embodiments, the door pull 10 may be located below the door handle 3. The door pull 10 may be installed on the door 1 offset from the floor 4 an elevation distance 11. This elevation distance 11 enables the user to comfortably utilize the door pull without requiring the user to bend or further contort their leg or tool. The elevation distance may be between 2 inches and 4 inches. In one implementation, the elevation distance is 3 inches. While the door pull 10 in FIG. 6 is shown to be installed parallel to the floor 4, i.e., the elevation distance 11 is shown to be constant across the door pull 10, it may be suitable for the door pull 10 to be installed at an angle with respect to the floor 4, as the present disclosure is not so limited. An angled installation of the door pull 10 may improve the functionality or ergonomics of the door pull 10.

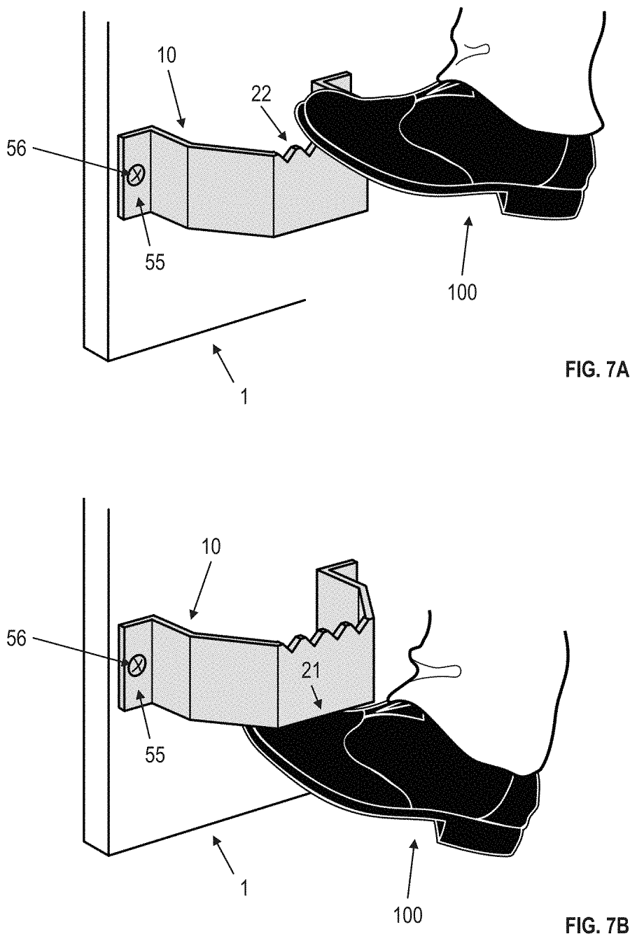

FIG. 7A shows an example of a typical use of one embodiment of the door pull 10 installed on a door 1 with through holes 55 holding fasteners 56. In this embodiment, the user places the sole of a shoe 100 on the upper edge 22 of the door pull. The trapezoidal teeth 22A on the upper edge 22 of the door pull 10 enable good contact with the sole of the shoe 100, and the user is able to actuate the door 1. In another example of a typical use, as depicted in FIG. 7B, the user places the toe box of a shoe 100 on the lower edge 21 of the door pull. The smooth surface of the lower edge 21 of the door pull 10 enables good contact with the smooth toe box of the shoe 100, and the user is able to actuate the door 1. In some embodiments, when the user's shoe 100 or tool makes good contact with the door pull 10, the user may either press or pull the door to actuate in a desired direction.

It should be appreciated that the various embodiments of the door pull described herein may be composed of a material to minimize long-term wear on the door pull, including but not limited to, plastic, glass, ceramic, brass, aluminum, wood, bronze, stainless steel, etc., or combinations thereof, as the present disclosure is not so limited. In addition, the door pull may be coated or painted with any suitable coloring, and may include any suitable surface finish, such as a gloss or matte finish, as the present disclosure is not so limited.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Thus, it should also be appreciated that features described herein as being part of one or more embodiments may be combined with or removed from other embodiments, as the present disclosure invention is not limited to any particular embodiment having any particular feature. Accordingly, the foregoing description and drawings are by way of example only.

What is claimed is:

1. A door pull operatively couplable to a door, comprising:
a central portion offset from the door by a clearance distance when the door pull is installed on the door, the central portion comprising an upper edge and a lower edge; and
a plurality of side portions, wherein the side portions are arranged to connect the central portion to the door,
wherein the upper edge comprises an upper topography and the lower edge comprises a lower topography that is different from the upper topography.

2. The door pull of claim 1, wherein the upper edge includes a plurality of trapezoidal teeth.

3. The door pull of claim 1, wherein the lower edge is smooth.

4. The door pull of claim 1, wherein the central portion is planar and wherein the central portion is arranged to be parallel to the door when the door pull is installed on the door.

5. The door pull of claim 1, wherein an outer surface of the central portion is convex relative to the door when the door pull is installed on the door.

6. The door pull of claim 1, in combination with the door, wherein the door pull is mounted on the door offset from a floor by an elevation distance.

7. The door pull of claim 1, wherein the clearance distance is between 2 and 4 inches when the door pull is installed on the door.

8. The door pull of claim 1, wherein the central portion comprises a width, wherein the width is about 2 inches.

9. A door pull operatively couplable to a door, comprising:
a central portion offset from the door by a clearance distance when the door pull is installed on the door, the central portion comprising an upper edge and a lower edge; and
a plurality of side portions, wherein the side portions are arranged to connect the central portion to the door,
wherein the upper edge includes a plurality of teeth and wherein the lower edge is relatively smooth.

10. The door pull of claim 9, in combination with the door, wherein the door pull is mounted on the door offset from a floor by an elevation distance.

11. The combination of claim 10, wherein the clearance distance is between 2 and 4 inches when the door pull is installed on the door.

12. The combination of claim 11, wherein the elevation distance is between 2 and 4 inches when the door pull is installed on the door.

13. The door pull of claim 9, wherein the central portion comprises a width, wherein the width is about 2 inches.
